(19) United States
(12) Patent Application Publication
(10) Pub. No.: US 2025/0189416 A1
(43) Pub. Date: Jun. 12, 2025

(54) CARTRIDGE FOR PRE-PURIFYING A SAMPLE OF RADIOLABELLED COMPOUNDS WITH A VIEW TO PURIFYING SAME BY HIGH-PRESSURE CHROMATOGRAPHY, PRE-PURIFICATION AND INJECTION DEVICE, AND PRE-PURIFICATION AND INJECTION METHOD

(71) Applicant: OUT AND OUT CHEMISTRY, Neuville (BE)

(72) Inventors: Yoann JOYARD, Lyon (FR); Nicolas MAINDRON, Venissieux (FR); Vincent TADINO, Chastres (BE)

(73) Assignee: OUT AND OUT CHEMISTRY, Neuville (BE)

(21) Appl. No.: 18/840,756

(22) PCT Filed: Feb. 20, 2023
(86) PCT No.: PCT/EP2023/054205

§ 371 Date: Aug. 22, 2024

(30) Foreign Application Priority Data
Feb. 24, 2022 (BE) BE2022/5131

(51) Int. Cl. G01N 1/34; B01L 3/00

(52) U.S. Cl. CPC G01N 1/34; B01L 3/502753; B01L 2200/027; B01L 2200/04; B01L 2200/0647; B01L 2300/0681

(57) ABSTRACT

Provided is a cartridge for the pre-purification of a liquid sample comprising radiolabelled compounds intended to be purified via high-pressure chromatography, comprising a casing filtration means, a chamber comprising a solid stationary phase and fluid communication means; the casing and the fluid communication means being capable of mechanically withstanding a fluid pressure greater than or equal to 50 bars. Also provided is a pre-purification and injection device integrating said cartridge and a pre-purification and injection method using said cartridge.

The invention relates to the field of synthesis and purification of radiolabelled compounds such as injectable radiolabelled tracers, for example, for positron emission tomography (PET) analyses. In particular, the invention relates to a cartridge for the pre-purification of a raw liquid sample resulting from a synthesis of radiolabelled compounds, with a view to analysing/separating/purifying it via high-pressure chromatography. The invention also relates to a device and a method for the pre-purification and injection of a liquid sample of radiolabelled compounds into a high-pressure chromatography system.

The synthesis of radiolabelled compounds (or radiosynthesis) is generally based on “wet” chemistry where the radioactive synthon reacts, in a synthesis module or radiosynthesizer, with a non-radioactive precursor in a solution. Since the radioactive compound is intended to be injected into a patient's body, this approach necessarily requires a step involving the purification of the synthesis product (raw sample containing the radiolabelled compound(s)).

In order to purify a raw sample from radiosynthesis, a known and commonly used method is high-performance or high-pressure liquid chromatography (HPLC). This purification step must then be followed by a step of reformulation in a biocompatible solvent, as the usual HPLC solvents (e.g., acetonitrile) are not suitable for injection into the human or animal body.

For the purification of a raw sample from a synthesis of radiolabelled compounds, it is also known, but to a lesser extent and mainly for compounds labelled with Carbon 11 and for low levels of radioactivity, to use supercritical fluid chromatography (or SFC). This method uses a supercritical fluid as the mobile phase (commonly carbon dioxide), usually coupled with a cosolvent or “modifier” that changes its polarity (e.g. Ethanol). SFC allows for a faster separation step compared to HPLC (at least two to three times), which is a significant advantage in the case of short-lived radioactive isotopes as it improves the final synthesis yield. In addition, SFC eliminates the need for reformulation as the purified sample can be recovered in ethanol which is suitable for injection into the body after simple dilution (e.g. with saline or an aqueous buffer).

In both of these purification methods, the raw samples from radiosynthesis are generally injected into the chromatography column by means of an injection system comprising an injection loop and a valve, the loop allowing the injection of a maximum volume into the column equal to the volume of the loop (and the repeatability of said injected volume in the case of using the entire volume of the loop) while the valve allows the different elements (the “outlet” of the synthesizer, the loop, a pump, a “waste” container), etc. to be fluidly connected. A disadvantage of such a loop is that it limits the volume sent which is at most that of the loop, unless filling of the loop and injection takes place several times (automatically), but this is very time-consuming and should therefore be absolutely avoided in the case of radiosynthesis. In addition, in this case, there is always the risk of loss of yield, due to overflowing for example.

In particular, the HPLC method can be used to manage high injection volumes (up to 10 ml for example) and is therefore capable of a certain speed because the loop is loaded only once and to limit the loss of yield (due to loss of activity in the radiosynthesizer) because one or more rinsing operation(s) can be carried out in order to maximise the recovery of a raw sample from a synthesis of radiolabelled compounds. On the other hand, the dilution generated can reduce chromatographic performance and affect the purity of the final product.

In addition, in standard conditions, the SFC method requires a low-volume injection loop (less than 1 ml) because larger injection volumes would trigger violent decompression when the injection valve is reset to the loading position. The use of this separation method is therefore not suitable for syntheses of larger quantities, i.e. with volumes greater than 1 ml.

However, the configuration of conventional radiosynthesizers does not allow for automatic transfer without loss of radioactivity of volumes less than 1 ml. For raw sample volumes greater than 1 ml, in order to be able to use SFC and benefit from its aforementioned advantages, a (pre) concentration, via evaporation of the solvent for example, could be considered but the injection of a small volume into the loop would need to be manual in order to limit losses, which is unthinkable for the quantities of radioactivity used in production. In addition, the additional evaporation step, for example, would automatically impact the synthesis yield in the case of short-lived radioactive isotopes.

More specifically, there are also separation systems using the SFC (industrial preparative) method with a larger injection loop (e.g. 5 ml) but these systems are bulkier and very expensive. They have therefore found few applications in the synthesis of radiolabelled compounds.

In addition, due to the risk of encountering problems of clogging of the chromatography column, it is often necessary to first filter the raw sample resulting from a radiosynthesis, which again constitutes an additional step extending the time of the full synthesis-purification process. In addition, this filtration step requires a rigorous selection of filter in order to minimise losses on the filter membrane (for example, by chemical interaction). One object of this invention is to address the disadvantages of the prior art described above.

In particular, one object of the invention is to provide a device and a method for the pre-purification and injection of a raw sample resulting from a synthesis of radiolabelled compounds, into a high-pressure chromatography system, which lead to a reduction in the time required to obtain the purified radiolabelled compound compared to the systems from the prior art and which therefore give access to higher final yields. One object of the invention is also to provide a device and a method for the pre-purification and injection of a raw sample resulting from a synthesis of radiolabelled compounds, into a high-pressure chromatography system, regardless of the initial volume of said raw sample.

Another object of the invention is to provide a device and a method for the pre-purification and automated injection, without manual operation, of a raw sample resulting from a synthesis of radiolabelled compounds into a high-pressure chromatography system.

Another object of the invention is to provide a device and a method for the pre-purification and injection of a raw sample resulting from a synthesis of radiolabelled compounds, which allow one or more rinsing(s) of the radiosynthesizer (and therefore optimises the yield of the radiosynthesis, by minimising losses in the radiosynthesizer) without increasing the volume injected onto the column.

Another object of the invention is to provide a device and a method for the pre-purification and injection of a raw sample resulting from a synthesis of radiolabelled compounds, into a high-pressure chromatography system, which allow the injected volume to be controlled, regardless of the initial volume of said raw sample and therefore allowing better chromatographic reproducibility.

Yet another object of the invention is to provide a device and a method for the pre-purification and injection of a raw sample from a synthesis of radiolabelled compounds, which allow a single (automatic) injection to the chromatography system, regardless of the initial volume of the sample, and therefore saving time. Yet another object of the invention is to provide a device and a method for the pre-purification and injection of a raw sample from a synthesis of radiolabelled compounds, which also allow for filtration, therefore preventing any subsequent clogging of the chromatography column.

To achieve these aims, the invention provides a cartridge for the pre-purification of a liquid sample comprising radiolabelled compounds intended to be purified or analysed via high-pressure chromatography.

In particular, the cartridge of the invention comprises:
a casing,
filtration means,
a chamber whose volume is delimited by the casing and the filtration means, said chamber comprising a solid stationary phase, and
fluid communication means upstream and downstream of said chamber and said filtration means,
   said casing and said fluid communication means being capable of mechanically withstanding a fluid pressure greater than or equal to 50 bars.

The invention also provides a device for the pre-purification and injection of a liquid sample comprising radiolabelled compounds into a high-pressure chromatography system.

In particular, the device of the invention comprises:
a multi-way valve,
a means for supplying a liquid sample comprising radiolabelled compounds,
an elution phase pump,
a cartridge according to the invention,
a discharging means,
   said valve being in fluid communication with the supply means, the pump, the cartridge, the discharging means and a high-pressure chromatography system.

Finally, the invention also provides a method for the pre-purification and injection of a liquid sample comprising radiolabelled compounds into a high-pressure chromatography system.

In particular, the method of the invention comprises, in order:
(i) a loading step comprising:
   providing a cartridge according to the invention with a liquid sample comprising radiolabelled compounds through a multi-way valve in the loading position,
      the retention of radiolabelled compounds by the cartridge,
      the removal of elements not retained by said cartridge to a discharge means through the multi-way valve;
(ii) an injection step comprising:
   the aspiration by a pump of an elution phase through the multi-way valve in the injection position towards said cartridge,
   the release of the radiolabelled compounds retained by the cartridge,
   the introduction of the elution phase comprising the radiolabelled compounds into a high-pressure chromatography system through the multi-way valve.

The invention is therefore based on a new and inventive approach. In particular, the inventors have found, surprisingly, that by replacing, in the usual injection device in a high-pressure chromatography system (HPLC- or SFC-type), the injection loop with a cartridge comprising the characteristics of the invention, it was possible, whatever the initial volume of the sample comprising radiolabelled compounds, to significantly increase the synthesis yield by (i) significantly reducing the separation time (up to a factor of 4) and by (ii) allowing the rinsing of the radiosynthesizer (and therefore minimising the loss of compounds in the radiosynthesizer) without increasing the volume injected onto the column. For the sake of clarity, it is therefore understood that the usual injection loop in high-pressure chromatography systems is not included in the device of the invention, or in other words, the device of the invention does not include an injection loop.

Furthermore, the invention also makes it possible to avoid manual operations and to automate injection.

Other features, details and advantages of the invention are contained in the description and figures given below, without limitation.

In this description and the claims, it is clearly understood that, as used herein, the terms “a”, “an” or “the” mean “at least one” and should not be limited to “a single one”, unless explicitly indicated otherwise. The terms “comprise”, “include”, “contain” and “have” have an open meaning and do not exclude the presence of additional elements. Furthermore, when a range of values is indicated, the lowest and highest numbers are included. Finally, all integral and subdomain values in the numerical ranges are expressly included as if explicitly written.

According to the invention, the cartridge allows the pre-purification of a liquid sample comprising radiolabelled compounds intended to be purified or analysed via high-pressure chromatography.

According to the invention, the pre-purification of the liquid sample may also correspond to or include a concentration of the sample, in particular a concentration of the radiolabelled compounds.

In particular, the sample according to the invention may comprise one type of radiolabelled compound or several types of radiolabelled compounds. The radiolabelled compounds according to the invention are, for example, organic molecules, such as (i) sugars (e.g., glucose) or amino acids, carrying a radioisotope such as carbon-11, fluorine-18, iodine-131, yttrium-90 or actinium-225.

According to the invention, the liquid sample comprises radiolabelled compounds that are intended to be purified or analysed via high-pressure chromatography. The cartridge of the invention is in fact suitable for analytical chromatography (which makes it possible, for example, to detect the presence or formation of one or more compounds) or for preparative or semi-preparative chromatography (which makes it possible, for example, to collect one or more purified compounds from the raw sample resulting from a synthesis).

According to the invention, the liquid sample may be a sample in the aqueous phase or in the organic or biphasic phase (aqueous/organic) or an emulsion. Preferably, the liquid sample is a single-phase sample in aqueous phase. The aqueous phase according to the invention comprises at least 40% (by volume) of water and preferably at least 50% of water, or even at least 70% of water.

According to the invention, the cartridge comprises filtration means. The filtration means according to the invention make it possible (with the casing) to maintain/trap the solid stationary phase in the chamber by allowing the passage of fluids and by filtering the raw sample of potential solid particles (therefore preventing any clogging of the chromatography column during purification via high-pressure chromatography).

Preferably, the filtration means are chosen from filtration membranes and frits.

According to the invention, the cartridge comprises a chamber whose volume is delimited by the casing and the filtration means. Preferably, the chamber has a volume of between 50 and 2000 mm³. Most preferably, the chamber has a volume of between 50 and 1000 mm³. These volumes are particularly suitable for the volumes of liquid samples resulting from radiosynthesis.

According to the invention, the chamber comprises a solid stationary phase. “Solid stationary phase” relates to the definition commonly accepted in the field of separation/chromatography of chemical components in a mixture: the “solid stationary phase” is the compound in solid form used to retain/adsorb the components of a mixture to be separated. This phase is immobile, as opposed to the mobile phase (liquid or gaseous) which migrates through the stationary phase. The adsorption interactions occurring between the solid stationary phase and the components can be of various types: hydrogen bonds, hydrophobic/hydrophilic interactions, dipole-dipole interactions, ionic interactions, etc.

The solid stationary phase according to the invention advantageously comprises particles with a size in the range between 20 and 100 microns, preferably between 30 and 80 microns.

The solid stationary phase according to the invention may be of the reverse phase type or of the normal phase type or of the ion exchange type or of the mixed mode type. The solid stationary phase of the invention is chosen according to the radiolabelled components to be purified (and therefore to be retained). Therefore, it can be more or less polar.

According to a preferred embodiment of the invention, the solid stationary phase is of the reverse phase type. According to this embodiment, preferably, the solid stationary phase is of the C8 type (phase based on silica grafted with octane chains), C18 (phase based on silica grafted with octadecyl chains) or HLB. Most preferably, the solid stationary phase is of the C18 type.

According to another embodiment of the invention, the solid stationary phase is of the “mixed mode” type. Mixed mode type solid stationary phase refers to a combination of the reverse phase type and the ion exchange type. Examples are the stationary phases called MCX (“strong cation exchange”), MAX (“strong anion exchange”), WCX (“weak cation exchange”) or WAX (“weak anion exchange”).

The solid stationary phase according to the invention is trapped/retained in the chamber by virtue of the casing and the filtration means delimiting the volume of the chamber.

According to one embodiment, the solid stationary phase occupies at least 70% of the volume of the chamber (without considering the possible microscopic porosity of the solid stationary phase). Preferably, it occupies at least 80% of the volume of the chamber, or even at least 90% of the chamber volume. This makes it possible to have fewer “dead volumes” in the cartridge of the invention, which is advantageous for, on the one hand, controlling (for example, reducing) the injection volume and therefore improving purification via chromatography, and on the other hand, making it possible to inject a maximum of the radiolabelled compounds into the chromatography system (and thus increasing the yield).

Advantageously, one or more chemical reaction(s) involving radiolabelled components retained on the solid stationary phase may be carried out in the cartridge of the invention. Examples of the chemical reactions that can be carried out are: basic or acid hydrolysis, reduction, oxidation and halogenation.

According to the invention, the cartridge comprises fluid communication means upstream and downstream of the chamber and filtration means. In particular, the fluid communication means according to the invention are adjacent to the filtration means. The fluid communication means and the filtration means are thus arranged to allow the passage of a liquid from upstream to downstream through the chamber.

The fluid communication means upstream and downstream of the chamber and the filtration means according to the invention can be of the type conventionally used in the field of high-pressure chromatography.

According to the invention, the casing and the fluid communication means are capable of mechanically withstanding a fluid pressure greater than or equal to 50 bars, preferably greater than or equal to 100 bars and most preferably greater than or equal to 150 bars.

According to one embodiment, the casing and/or the communication means are made of a material chosen from PEEK or stainless steel or Teflon or polyoxymethylene. Preferably, the casing and the communication means are made of a material chosen from PEEK or stainless steel or Teflon or polyoxymethylene (POM). More preferably, the casing and/or the communication means are made of a material chosen from PEEK or stainless steel. Most preferably, the casing and the communication means are made of a material chosen from PEEK or stainless steel. The material of the casing and the communication means can be chosen separately.

According to one embodiment, when the cartridge casing is made of PEEK, said casing has a minimum thickness of 0.6 mm, and preferably, a minimum thickness of 1 mm, and more preferably, a minimum thickness of 2.5 mm. These thicknesses allow the cartridge of the invention to mechanically withstand the high pressures required for the targeted chromatography systems, i.e. a fluid pressure greater than or equal to 50 bars, greater than or equal to 100 bars and greater than or equal to 150 bars, respectively.

According to another embodiment, when the cartridge casing is made of stainless steel, said casing has a minimum thickness of 0.25 mm, and preferably, a minimum thickness of 0.75 mm, and more preferably, a minimum thickness of 1 mm. These thicknesses allow the cartridge of the invention to mechanically withstand the high pressures required for the targeted chromatography systems, i.e. a fluid pressure greater than or equal to 50 bars, greater than or equal to 100 bars and greater than or equal to 150 bars, respectively.

According to another embodiment, when the cartridge casing is made of Teflon, said casing has a minimum thickness of 5 mm, and preferably a minimum thickness of 8 mm, and more preferably a minimum thickness of 12 mm. These thicknesses allow the cartridge of the invention to mechanically withstand the high pressures required for the targeted chromatography systems, i.e. a fluid pressure greater than or equal to 50 bars, greater than or equal to 100 bars and greater than or equal to 150 bars, respectively.

According to another embodiment, when the cartridge casing is made of polyoxymethylene, said casing has a minimum thickness of 2 mm, preferably a minimum thickness of 4 mm, and more preferably a minimum thickness of 5 mm. These thicknesses allow the cartridge of the invention to mechanically withstand the high pressures required for the targeted chromatography systems, i.e. a fluid pressure greater than or equal to 50 bars, greater than or equal to 100 bars and greater than or equal to 150 bars, respectively.

In the case where the casing has a thickness that varies in the width and/or length of the cartridge, the minimum thickness of the casing according to the invention must be achieved along its full width and its full length.

According to the invention, the device for pre-purification and injection into a high-pressure chromatography system of a liquid sample comprising radiolabelled compounds comprises:
a multi-way valve,
a means for supplying a liquid sample comprising radiolabelled compounds,
   an elution phase pump,
   a cartridge according to the invention,
   a discharging means,
      said valve being in fluid communication with the supply means, the pump, the cartridge, the discharging means and a high-pressure chromatography system.

For the sake of clarity and as already explained above, the usual injection loop in high-pressure chromatography systems is not included in the device of the invention and replaced by said cartridge, or in other words, the device of the invention does not include an injection loop.

According to one embodiment of the device of the invention, the multi-way valve is a rotary valve, a solenoid valve or a pneumatic valve. The multi-way valve of the invention may for example comprise 4 ways, 6 ways, 8 ways or 10 ways.

According to one embodiment of the device of the invention, the means for supplying a liquid sample is an outlet of a radiosynthesis module.

According to one embodiment of the device of the invention, the pump is in fluid communication with an elution phase reservoir.

According to one embodiment of the device of the invention, the discharge means is in fluid communication with a “waste” reservoir.

Advantageously, the device of the invention may also comprise a means for heating the cartridge, in particular the chamber of the cartridge. This makes it possible to increase the temperature of the stationary phase above ambient temperature, which may aid adsorption/desorption on the stationary phase, or be beneficial or even necessary in the case where one or more chemical reactions are carried out in the cartridge and require temperatures above ambient temperature to occur effectively. For example, a heating means adapted to the invention consists of a heating sleeve surrounding the cartridge.

According to one embodiment of the device of the invention, the high-pressure chromatography system is of the HPLC or SFC type.

Preferably, the chromatography system is of the SFC type. SFC type chromatography is advantageous in that it allows rapid separation and makes it possible to dispense with a reformulation step because the purified compound can be recovered in a biocompatible solvent (e.g., ethanol).

When the chromatography system is of the SFC type, a mixing chamber is provided in fluid communication with (i) the multi-way valve of the device of the invention, (ii) a chromatography column, and (iii) a supercritical fluid pump, for example a CO₂ pump.

Also advantageously, when the chromatography system is of the SFC type, the pump of the device of the invention can be used to provide a cosolvent or modifier which makes it possible, for example, to modify the polarity of the supercritical fluid. In this case, said elution phase constitutes said cosolvent. Preferably, according to this embodiment, the elution phase is ethanol.

Alternatively, the chromatography system is of the HPLC type. When the chromatography system is of the HPLC type, a chromatography column is provided in fluid communication with the multi-way valve of the device of the invention.

According to the invention, the method for the pre-purification and injection into a high-pressure chromatography system of a sample comprising radiolabelled compounds, comprises, in order, a loading step and an injection step.

According to the invention, the loading step comprises
providing a cartridge according to the invention with a liquid sample comprising radiolabelled compounds through a multi-way valve in the loading position,
the retention of the radiolabelled compounds by the cartridge,
the discharge of elements not retained by said cartridge to a discharge means through the multi-way valve.

According to the invention, in the loading step, the multi-way valve is in the loading position.

According to the invention, advantageously, the liquid sample can come directly from a radiosynthesis module.

According to a preferred embodiment, the volume of the sample comprising radiolabelled compounds is between 0.5 ml and 20 ml. Preferably, the volume of the sample comprising radiolabelled compounds is between 1 and 15 ml, or even between 5 ml and 10 ml.

According to the invention, in the loading step, the retention of the radiolabelled compounds by the cartridge is achieved thanks to the stationary solid phase which makes it possible to trap (for example, by adsorption), among other things, the radiolabelled compounds. Other components of the sample can be retained on the stationary phase depending on their affinity for said phase (for example, the synthesis precursor(s)). The elements not retained by the cartridge, for example the synthesis solvent(s), are on the other hand discharged to a discharge means, for example in fluid communication with a “waste” reservoir.

According to a particular embodiment of the loading step, the retention of the radiolabelled compounds by the cartridge can be accompanied by chemical reaction(s) of said radiolabelled compounds in the cartridge, in particular on said solid stationary phase. Examples of chemical reactions which can be carried out according to this embodiment are basic or acid hydrolyses, reductions, oxidations and halogenations. Said reactions can be carried out at ambient temperature or at temperatures above ambient temperature. In the case where temperatures above ambient temperature are necessary or useful, a heating sleeve may be provided, surrounding the cartridge, in particular its casing.

According to the invention, the injection step comprises:
the aspiration by a pump of an elution phase through the multi-way valve in the injection position towards said cartridge,
the release of the radiolabelled compounds retained by the cartridge,
the introduction of the elution phase comprising the radiolabelled compounds into a high-pressure chromatography system through the multi-way valve.

The release of the radiolabelled compounds may be accompanied by the release of other organic compounds (synthesis residues, precursors, etc.) also retained on the cartridge.

According to the invention, in the injection step, the multi-way valve is in the injection position.

According to the invention, in the injection step, an elution phase is aspirated by a pump towards the cartridge, causing the release (e.g., by desorption) in the elution phase of the radiolabelled compounds retained by the cartridge.

Said elution phase comprising the radiolabelled compounds is then introduced into a high-pressure chromatography system. Preferably, the high-pressure chromatography system is of the HPLC or SFC type and, most preferably, of the SFC type, for the reasons previously stated above.

According to a particular embodiment, the elution phase is, for example, methanol, ethanol, acetonitrile, water or an aqueous solution. Additives may also be added to, for example, influence the pH of the elution phase (for example, triethylamine, acetic acid, etc.).

When the high-pressure chromatography system is of the SFC type, the elution phase is advantageously ethanol. Ethanol is a cosolvent (or modifier) suitable for SFC and it is a biocompatible solvent which makes it possible to facilitate the reformulation step (for example, by reducing it to simple dilution with water or a saline solution or any other biocompatible buffered solution).

When the high-pressure chromatography system is of the SFC type, according to an alternative embodiment, the elution phase is the supercritical phase, preferably CO₂. Advantageously, the elution phase may be a mixture of the supercritical phase, for example CO₂, and a modifier, for example ethanol.

According to the method of the invention, the elution phase comprising the radiolabelled compounds is introduced into a high-pressure chromatography system, said system comprising a chromatography column.

The other elements of the chromatography system, in particular of the HPLC or SFC type, and the purification or analysis steps are known from the prior art without it being necessary to detail them further here.

According to a particular embodiment, the method of the invention comprises, after the loading step and before the injection step, at least one secondary loading step, comprising:
providing, through the multi-way valve in the loading position, the cartridge with a secondary liquid fraction comprising radiolabelled compounds,
the retention of the radiolabelled compounds by the cartridge,
the discharge of elements not retained by said cartridge to a discharge means through the multi-way valve.

According to this embodiment, the multiport valve is in the loading position.

“Secondary liquid fraction” refers to a fraction that comes from rinsing/cleaning with a cleaning phase of the sample supply means and/or a radiosynthesis module located upstream of the supply means, or to a second liquid sample comprising radiolabelled compounds (this step is then a repetition of the loading step).

According to this method, the secondary liquid fraction therefore “loads” the cartridge further, already loaded with radiolabelled compounds from the liquid sample at the loading step according to the invention.

In the case where the secondary liquid fraction comes from one or more rinsing/cleaning operations, the elements not retained by the cartridge and which are discharged to the discharge means are mainly composed of the cleaning phase.

The device and method of the invention therefore very advantageously allow several rinsings of the elements located upstream of pre-purification and injection (synthesis module, supply means, etc.), thus increasing the synthesis yield, without increasing the injection volume because the cleaning phase is eliminated/discharged (thus avoiding dilution which is detrimental to chromatographic performance and the purity of the final product).

According to this embodiment, the cleaning phase is chosen from water, aqueous buffers and organic solvents. Preferably, the cleaning phase is water.

According to another particular embodiment, the method of the invention comprises, after the injection step, a cartridge regeneration step. According to this embodiment, in the regeneration step, the multiport valve is in the loading position.

The regeneration step comprises, in order, (i) providing the cartridge with a regeneration phase, and (ii) discharging said phase to a discharge means. This step makes it possible to completely clean the cartridge, in particular the solid stationary phase, of any residues and to return it to its initial state in order to allow a new “loading-injection” cycle. This is particularly advantageous because the cartridge of the invention can therefore be reused a certain number of times.

According to this embodiment, the regeneration phase is chosen from water, aqueous buffers and organic solvents. Preferably, the regeneration phase is the elution phase.

Exemplary embodiments of the invention are described with the aid of the figures. It should be understood that these figures are merely examples of how the invention can be implemented, and are in no way intended to be interpreted as limiting the scope of the invention and the claims. In the figures:

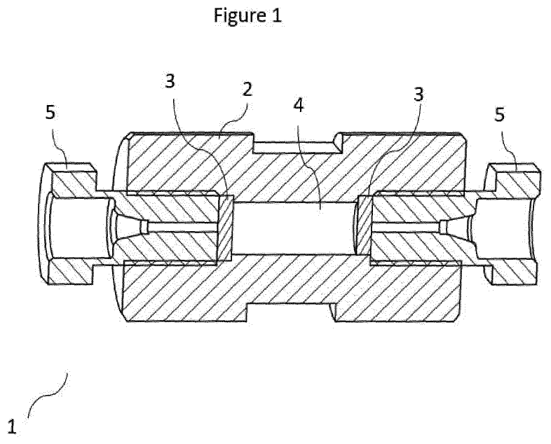

FIG. 1 is a side sectional view of a possible embodiment of a pre-purification cartridge according to the invention.

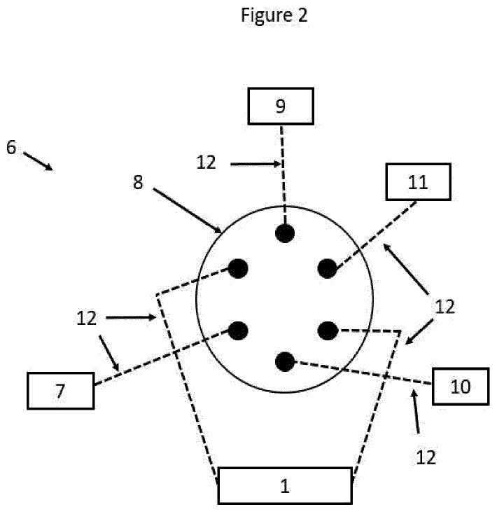

FIG. 2 represents a possible embodiment of a pre-purification and injection device according to this invention.

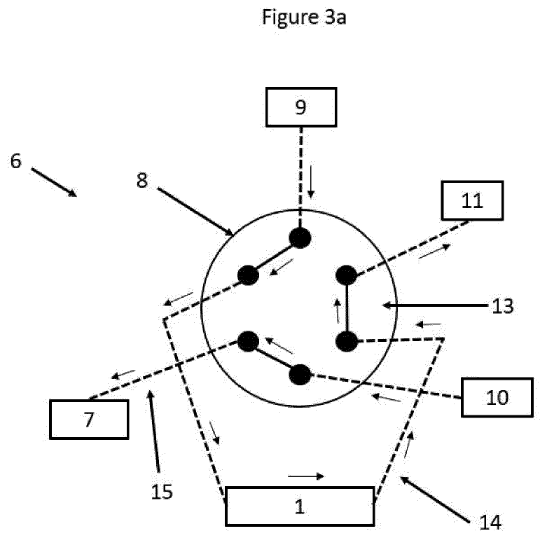

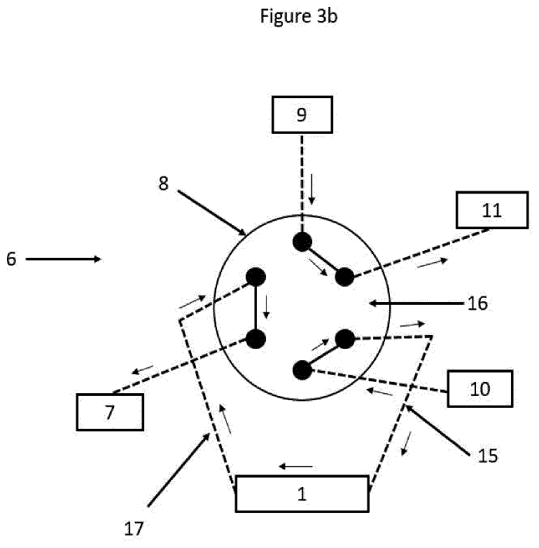

FIG. 3a illustrates a possible embodiment of a device according to this invention, in the loading position.

FIG. 3b illustrates a possible embodiment of a device according to this invention, in the injection position.

In the figures, identical or similar elements have the same references. The reference numbers in the claims should not be interpreted as limiting the invention.

FIG. 1 illustrates a cartridge (1) for the pre-purification of a sample comprising radiolabelled compounds intended to be purified or analysed by high-pressure chromatography.

The cartridge (1) comprises a casing (2), the casing (2) is made of PEEK (material capable of withstanding high pressures as in the case of SFC- or HPLC-type chromatography) with a thickness of 4.5 mm.

The cartridge (1) also comprises filtration means (3).

The cartridge (1) comprises a chamber (4) whose volume is delimited by the casing (2) and the filtration means (3).

The cartridge (1) also comprises PEEK fluid communication means (5), upstream and downstream of the chamber (4) and the filtration means (3). These communication means (5) make it possible to fluidly connect the cartridge (1) to the device in which it will be integrated (for example the device according to the invention described below). The fluid communication means (5) are adjacent to the filtration means. The fluid communication means (5) and the filtration means (3) allow the passage of the liquid sample from upstream to downstream through the chamber.

The chamber (4) comprises a solid stationary phase of the reverse phase C18 type for retaining the radiolabelled compounds (e.g., by adsorption). The solid stationary phase thus advantageously allows for pre-purification of the sample. The filtration means (3) make it possible (with the casing) to maintain the solid stationary phase in the volume of the chamber while allowing the passage of the liquid sample by filtering it of potential solid particles (therefore advantageously preventing any clogging of the column during subsequent purification via high-pressure chromatography).

FIG. 2 illustrates a pre-purification and injection device (6) in a high-pressure chromatography system (7) for a liquid sample comprising radiolabelled compounds. The device (6) comprises a 6-way multi-way valve (8). This multi-way valve (8) makes it possible to fluidly connect (12) all the elements of the device together, in particular a supply means (9), an elution phase pump (10), a cartridge (1), a discharge means (11). The valve also makes it possible to fluidly connect (12) a high-pressure chromatography system (7) to the device of the invention. The supply means (9) makes it possible to supply the device (6) with liquid samples of radiolabelled compounds, for example coming from a radiosynthesis module. The elution phase pump (10) is used to aspirate an elution phase in the device (6). The cartridge (1) allows for the pre-purification of the liquid sample including radiolabelled compounds.

FIGS. 3a and 3b illustrate embodiments of the device (6) from FIG. 2 in operation as well as of the method of the invention.

FIG. 3a illustrates the loading step. In this first step, the multi-way valve (6-way) (8) is in the loading position (13). The loading position (13) makes it possible to supply the cartridge (1) with liquid samples comprising radiolabelled compounds by means of the supply means (9). When the sample passes through the cartridge (1), the radiolabelled compounds are retained by the solid stationary phase. This therefore advantageously makes it possible to concentrate and/or pre-purify the radiolabelled compounds at this stage of the process. The elements not retained (14) by the cartridge (1) (i.e. the components having little or no affinity with the stationary phase) flow beyond the cartridge, through the multi-way valve (8) to a discharge means (11).

The loading position can also be used to carry out a secondary loading step, by supplying the cartridge (1) via the supply means (9) with a secondary liquid fraction comprising radiolabelled compounds (e.g., a fraction which comes from rinsing/cleaning with a cleaning phase for a radiosynthesis module located upstream of the supply means (9)). In this case, the secondary liquid fraction therefore “loads” the cartridge further, already loaded with radiolabelled compounds from the liquid sample supplied in the first loading step. During this secondary loading step (which can be repeated), the radiolabelled compounds coming from, for example, the cleaning of a synthesis module are therefore recovered on the cartridge and will help to improve the radiosynthesis yield. On the other hand, the cleaning phase and other elements not retained on the cartridge will be removed to the discharge means (11). This therefore allows the cleaning of the radiosynthesis module and the supply means in order to recover as much of the radiolabelled compounds as possible, without impacting the final volume of the sample to be injected into the chromatography system (7). Indeed, this volume can be chosen/controlled during the next injection step.

In addition, in this loading step and in the usual way the elution phase (15) can be sent directly to the chromatography system (7) through the multi-way valve (8). This makes it possible to balance the chromatography column during the loading of the cartridge (1).

FIG. 3b illustrates the injection step. In this second step of the process, the multiport valve (8) is in the injection position (16). The injection position (16) makes it possible to elute the cartridge (1) of the radiolabelled compounds retained therein and to inject the concentrated and/or pre-purified sample into a chromatography system (7) for purification (or analysis). This also makes it possible to filter the sample beforehand through the cartridge (1) and therefore prevent the clogging of the chromatography column. In this injection step, a pump (10) draws an elution phase (15) through the multiport valve (8) towards said cartridge (1), which causes the release of the radiolabelled compounds retained by the cartridge (1), which are therefore eluted. The elution phase comprising the radiolabelled compounds (17) is then injected into the high-pressure chromatography system (7) through the multi-way valve (8). The elution phase comprising the radiolabelled compounds (17) therefore constitutes a concentrated and/or pre-purified sample compared to the initial sample (before passing through the cartridge). In particular, the initial volume could be adapted (for example, reduced), the solvent could be modified, certain elements (those not retained by the cartridge) were removed, and any solid particles present could be filtered.

In addition, in this injection step, the supply means (9) is in fluid connection with the discharge means (11). This makes it possible to clean the supply means (9), and to rinse it before the next loading phase. This has the advantage of reducing the risks of subsequent contamination and/or the risk of the formation of aggregates which could block the system and require maintenance.

It is understood that this invention is in no way limited to the embodiments described above and that modifications can be made without departing from the scope of the claims. It is further understood that the invention also encompasses all possible combinations of features and preferred features described herein and mentioned in the claims.

In addition, the following example is provided for illustration purposes and is not intended to limit the scope of this invention.

### Example

This example corresponds to the automated purification of a radioactive tracer labelled with fluorine-18, the compound [¹⁸F]-AV-45, with a cartridge, a device and a method according to the invention. A cartridge according to the invention, made of PEEK and with a volume of 785 mm², was manually filled with 90 mg of stationary phase of the HLB type (Hydrophilic-Lipophilic Balance, Waters HLB Plus Short cartridge reference no. 186000132) whose particle size is 50-65 microns.

Automated radiosynthesis (trapping of fluorine-18 on a QMA cartridge, elution of fluorine-18, drying of fluorine-18 in the reactor, labelling, hydrolysis, neutralisation) was carried out on a first module (NEPTIS® xSeed™) with 2.0 mg of precursor in 2.0 ml of DMSO.

The neutralised reaction raw was diluted manually with water to 10 mL with a 10 mL luer-lock syringe. This was manually placed in a syringe pump and the loading of the cartridge according to the invention was then carried out automatically. The speed of the syringe pump was 4 mm/6 sec and a relative vacuum of −0.9 bar was applied. Once loading was complete, the syringe was not rinsed, and the operator activated the injection valve (8) in injection mode (according to FIG. 2) via the NEPTIS® software.

The UV trace was recorded by simultaneously and manually launching acquisition via the SFC module software.

In order to monitor the fluorine-18 labelled product, a radio detector was placed in contact with the cartridge and a second one was placed at the outlet of the SFC purification system. This second radio detector allowed the operator to activate a collection valve in order to collect the radioactive peak in the collection vessel.

For this example, the activity present in the 10 ml syringe before loading onto the cartridge was 11.4 mCi (420 Mbq).

The “semi-prep” column used was a Phenomenex Polar RP 10 μm, 250×10 mm column.

The SFC conditions were as follows:
Eluent: CO₂/ETOH 95/5;
Flow rate: 20 mL/min;
Pressure regulator at 150 bars and heated to 60° C.;
UV detection at 254 nm;
Temperature of the SFC system: between 25 and 30° C.

According to the measurements carried out, 90% of the activity on the cartridge was eluted in 1 minute, with the eluent CO₂/EtOH 95/5.

The radioactive peak linked to the compound [¹⁸F]-AV-45 emerges between 6′20″ and 7′30″. For comparison, in HPLC purification [¹⁸F]-AV-45 is normally eluted at around 15′.

At the end of collection, the final vessel was manually unscrewed from the collection module and inserted into an activimeter in order to measure its activity.

The results from this example are presented in the following table (residual activity and synthesis yield measurements during the process (AO: initial activity; d.c.: “decay corrected”, corrected for the decay of fluorine-18).

| | A | t + t0 | A | % A0 |
|---|---|---|---|---|
| | (mCi) | (min) | (mCi, d.c.) | (d.c.) |
| A0 on QMA | 13.95 | 0 | | 100 |
| (NEPTIS ® xSeedTM module) | | | | |
| End of neutralisation | | 18 | | |
| Activity in 10 mL syringe | 11.41 | 24 | 13.28 | 95.0 |
| Start of SFC purification | | 27 | | |
| End of peak collection | | 35 | | |
| Collection vessel | 4.16 | 50 | 5.70¹ | 41.0 * |
| Cartridge waste trapping | 4.23 | 51 | 5.84 | 42.0 ** |
| SFC purification waste | 0.56 | 53 | 0.78 | 5.6 |
| SFC column rinsing | 0.03 | 65 | 0.05 | 0.3 |
| 10 mL syringe | 0.10 | 66 | 0.15 | 1.0 |
| Activity recovered | | | | 89.9 |

* At the end of synthesis, t0 + 35 min, the activity would have been 4.57 mCi, i.e. a yield of 33% not corrected for decay.
** 4% of the activity of the liquid waste linked to the loading of the cartridge is of the labelled product.

1. A cartridge, said cartridge comprising:
a casing,
a filtration means,
a chamber whose volume is delimited by said casing and the filtration means, said chamber comprising a solid stationary phase, and
a fluid communication means upstream and downstream of said chamber and said filtration means,
said casing and said fluid communication means being capable of mechanically withstanding a fluid pressure greater than or equal to 50 bars,
wherein the cartridge is for the pre-purification of a liquid sample comprising radiolabelled compounds intended to be purified or analyzed via high-pressure chromatography.

2. The cartridge according to claim 1, wherein said casing and said communication means are capable of mechanically withstanding a fluid pressure greater than or equal to 100 bars.

3. The cartridge according to claim 1, wherein the casing and/or the communication means are made of a material chosen from PEEK or stainless steel.

4. The cartridge according to claim 1, wherein said solid stationary phase is of the reverse phase type.

5. The cartridge according to claim 1, wherein said chamber has a volume of between 50 and 2000 mm³.

6. A device, said device comprising:
a multi-way valve
a means for supplying a liquid sample comprising radiolabelled compounds,
an elution phase pump,
a cartridge, and
a discharge means,
said valve being in fluid communication with the supply means, the pump, the cartridge, the discharge means and a high-pressure chromatography system,
wherein the device is for the pre-purification and injection into a high-pressure chromatography system of a liquid sample comprising radiolabelled compounds.

7. The device according to claim 6, wherein said chromatography system is of the HPLC or SFC type.

8. The device according to claim 6, wherein said chromatography system is of the SFC type.

9. A method for the pre-purification and injection into a high-pressure chromatography system of a liquid sample comprising radiolabelled compounds, using the device according to claim 6.

10. A method, said method comprising, in order:
(i) a loading step comprising:
supplying through a multi-way valve in a loading position a cartridge with a liquid sample comprising radiolabelled compounds,
the retention of the radiolabelled compounds by the cartridge, and
the discharge of elements not retained by said cartridge to a discharge means through the multi-way valve; and
(ii) an injection step comprising:
the aspiration by a pump of an elution phase through the multi-way valve in the injection position towards said cartridge,
the release of the radiolabelled compounds retained by the cartridge, and
the introduction of the elution phase comprising the radiolabelled compounds into a high-pressure chromatography system through the multi-way valve,
wherein the method is for pre-purification and injection of the high-pressure chromatography system of the liquid sample comprising radiolabelled compounds.

11. The method according to the claim 10, wherein the high-pressure chromatography system is of the HPLC- or SFC-type.

12. The method according to claim 10, wherein the high-pressure chromatography system is of the SFC-type.

13. The method according to claim 10, wherein the elution phase comprises ethanol.

14. The method according to claim 10, wherein the method further comprises, after said injection step, a step of regenerating said cartridge comprising, in order:
supplying, through the multi-way valve in the loading position of the cartridge, a regeneration phase, and
discharging said regeneration phase to a discharge means through the multi-way valve.

15. The method according to claim 14, wherein the regeneration phase is selected from among water, aqueous buffers and organic solvents.

16. The device according to claim 6, wherein the cartridge is the cartridge according to claim 1.

17. The method according to claim 10, wherein the cartridge is the cartridge according to claim 1.

18. A method for the pre-purification and injection into a high-pressure chromatography system of a liquid sample comprising radiolabelled compounds, using the device according to claim 7.

19. A method for the pre-purification and injection into a high-pressure chromatography system of a liquid sample comprising radiolabelled compounds, using the device according to claim 8.
